(19) United States
(12) Patent Application Publication
(10) Pub. No.: US 2006/0065597 A1
(43) Pub. Date: Mar. 30, 2006

(54) Hybrid, reverse osmosis, water desalinization apparatus and method with energy recuperation assembly

(75) Inventor: Jan K. Kunczynski, La Paz (MX)

Correspondence Address: ROBERT B. CHICKERING, ESQ.;Dorsey & Whitney LLP, Intellectual Property Department, Four Embarcadero Center, Suite 3400, San Francisco, CA, 94111-4187, US

(73) Assignee: SISYAN, R.L. de C.V.

(21) Appl. No.: 10/954,761

(22) Filed: Sep. 29, 2004

(51) Int. Cl. B01D 61/12

(52) U.S. Cl. 210/637; 210/652; 210/258; 210/137; 210/321.66; 210/143

(57) ABSTRACT

A reverse osmosis water desalinization system (21) having a reverse osmosis cell (31), a hydraulic pump (34), a motor (39), which is preferably an electric motor and is coupled to drive the pump (34), a conduit array for flow of water through the cell and the rest of the system, and an energy recouperation assembly (22) formed to recover energy from the brine stream from the cell (31) and to input the recovered energy into the pump (34). The energy recouperation assembly (22) preferably includes a fixed displacement hydraulic motor 38 mechanically coupled through a stepless, adjustable ratio increaser assembly to drive pump (34). In a preferred form, the electrical motor (39) is powered by a hybrid photovoltaic/battery bank assembly (42,43) and controlled by a controller (44) which operates the pump (34) only during daylight hours at speed determined by, and with preference given to, the availability of solar power. A water desalinization method also is disclosed.

### TECHNICAL FIELD

The present invention relates, in general, to reverse osmosis water desalinization systems, and more particularly, relates to hybrid, reverse osmosis, water desalinization systems which include energy recuperation assemblies.

### BACKGROUND ART

Considerable effort has been expended in the development of reverse osmosis based water desalinization systems. Such desalinization apparatus typically have had the most success when design for large installations, for example, as might be operated by a municipality in an area or geography in which fresh water is in low supply and is expensive to procure. In various desert regions, for example, large reverse osmosis-based water desalinization systems have been successfully employed. While these systems are often more costly than competitive systems for supplying fresh water, this cost can be justified, and it can even be the most economical approach in desert areas of the world, particularly when large installations are constructed and operational efficiency improved.

As large desalinization systems are scaled down, in an attempt to use this approach as a fresh water source for individual homes, boats or small groups of homes, reverse osmosis water desalinization systems tend to become very costly and very low in their energy efficiency. Accordingly, reverse osmosis water desalinization systems are not frequently used for smaller installations.

Reverse osmosis water desalinization systems can be powered in a variety of ways, including using grid electricity, generators, photovoltaic energy, diesel and propane engines, fuel cells, etc. Since the economics of reverse osmosis water desalinization often become attractive in desert climates in which solar energy is abundant, many reverse osmosis water desalinization systems have been powered, at least in part, by arrays of photovoltaic panels.

Accordingly, a common well-known approach to powering reverse osmosis water desalinization systems is to use a power system in which there is a combination of solar energy and batteries, which combination which is sometimes referred to as a “hybrid” reverse osmosis water desalinization system. Such hybrid systems can also be backed up or further hybridized by fossil fuel power and/or electrical grid power.

It is also common and well known for reverse osmosis water desalinization systems to employ energy recuperation assemblies, regardless of the manner in which they are powered. In a reverse osmosis water desalinization system the water being treated, most often but not exclusively sea water, will be pumped into the reverse osmosis cell from which there are two outputs. The treated water having passed through the cell membrane and having substantially reduced salt content flows out of one of the output conduits of the cell, and the brine or water, in which the salt content is substantially increased by reason of not being able to pass through the water permeable membrane of the cell, flows out of the other output conduit. The brine output from the reverse osmosis cell will have considerable energy remaining in it by reason of the high pumping pressures used to force the input water into the cell. Thus, it is well known to extract some of the energy from the brine output side of the cell and use this extracted, or recuperated, energy to help drive the pump which inputs the water into the cell. Such energy recuperation from the brine stream has typically been accomplished by employing pressure exchangers, Pelton wheel turbines and axial piston pumps employed as hydraulic motors. An adjustable displacement axial piston motor, for example, is coupled to a pump in U.S. Pat. No. 6,299,766 to Permar. The high corrosion inherent in the concentrated brine stream, however, makes it difficult to operate this system for long periods of time while still being able to adjust the displacement of the motor internally in the corrosive environment.

Coupling a hydraulic motor to extract energy from the brine stream and to apply it to the pump is generally an effective way of recuperating energy. The recouperated energy helps to increase the system's efficiency and to reduce the cost of operation of the reverse osmosis water desalinization system. However, it is always a goal to obtain the lowest cost per gallon of water produced from desalinization apparatus. This means that increasing the efficiency of energy recouperation under the dynamic operating conditions of the system is extremely important. The cost per gallon of treated water also can be reduced by increasing the reliability of all of the components, reducing the maintenance of the components.

Moreover, while hybrid photovoltaic and battery desalinization apparatus are broadly known in the prior art, the choices possible in connection with the capacity of photovoltaic panels and battery storage are considerable. For example, one approach is to have enough photovoltaic panels and a large enough battery storage bank to allow water processing 24 hours a day, with the panels charging the batteries during daylight hours and the batteries discharging when the sunlight is not sufficient to operate the system using the panels. Another approach is to operate the reverse osmosis system only during daylight hours which provide sufficient solar energy to drive the panels, approximately 8 to 9 hours each day. The 24 hour per day system obviously will produce more water than the 8 hour per day system, unless the 8 hour per day system is made much larger than the 24 hour per day system.

Another tradeoff occurs between the osmotic pressure at which the system operates and the quality of the desalinized water produced. The reverse osmosis cell efficiency is increased at higher pressures; however, forcing too much sea water through the membrane may not allow adequate flow of brine to efficiently wash the membrane. The relationship between the pressure on the cell, water quantity and water quality (salinity) and the energy required is not linear. These relationships also effect the quality of desalted water produced at start-up and stopping of the system, if the system is not run 24 hours a day.

Thus, reverse osmosis water desalinization systems involve a myriad of tradeoffs, and most of these considerations do not scale linearly with size, making the creation of the system for an individual home owner which is efficient and cost effective very difficult to achieve.

Accordingly, it is an object of the present invention to provide a reverse osmosis water desalinization system which has a size that is adaptable for use by an individual home owner and yet is relatively efficient and produces desalinized water at a reasonable cost.

Another object of the present invention is to provide a reverse osmosis water desalinization system and method having improved energy recuperation capability so as to enhance efficiency and reduce the cost of producing desalinized water.

Still a further object of the present invention is to provide a reverse osmosis water desalinization system and method in which a hybrid energy supply is used to optimize the cost of producing desalinized water.

Another object of the present invention is to provide a reverse osmosis water desalinization system and method in which the quality of the desalinized water and the overall efficiency of the system's operation can be controlled dynamically during operation of the system.

Another object of the present invention is to provide a reverse osmosis water desalinization system and method having improved durability and expected life of its components, relatively optimal initial investment costs, improved adaptability to site-specific modifications, a less susceptibility to temporary reductions in solar energy, having minimal environmental impact, and making more optimal use of solar energy.

The reverse osmosis water desalinization system and method of the present invention have other objects and features of advantage, which will be set forth in more detail in, and will be apparent from, the following Best Mode of Carrying Out the Invention and the accompanying drawings.

### SUMMARY OF THE INVENTION

The reverse osmosis water desalinization system of the present invention comprises, briefly, a reverse osmosis cell; a hydraulic pump; a motor coupled to drive the hydraulic pump; a conduit array fluid coupling the hydraulic pump to a source of water and fluid coupling the hydraulic pump to the cell for pumping water from the source through the cell; and an energy recuperation assembly including a fixed displacement hydraulic motor fluid coupled to receive brine output from the cell, and an adjustable ratio increaser assembly mechanically coupled between the output of the hydraulic motor and an input of the hydraulic pump. Most preferably, the energy recuperation assembly employs a stepless ratio increaser assembly in combination with a variable speed pulley assembly and a one-way clutch mechanism preventing rotation of the pump from being communicated back to the motor.

In another aspect of the present invention, the motor coupled to drive the pump is an electrical motor coupled to a hybrid battery and photovoltaic power assembly. The hybrid power source has a combination of photovoltaic panels and storage batteries which has been selected for operation of the reverse osmosis system during daylight hours only, with a power controller responsive to varying power output from the panels and the batteries to vary the rate at which water is pumped through the reverse osmosis cell in a manner tending to optimize efficiency.

In a further aspect of the present invention, a method of desalting water is provided which comprises, briefly, the steps of pumping water to be desalted into a reverse osmosis cell using a hydraulic pump; flowing brine output from the cell to a fixed displacement hydraulic motor; and mechanically coupling the output of the fixed displacement hydraulic motor to the input of the hydraulic pump by a stepless, adjustable, ratio increaser assembly.

In a final aspect, a method of desalting water of the present invention is comprised, briefly, of the steps of employing a hybrid battery and solar powered reverse osmosis desalinization apparatus; starting operation of the desalinization apparatus at a combination of solar energy and battery energy when solar power is above a solar power start threshold and battery power is above a battery power start threshold; increasing the use of solar power energy to operate the desalinization apparatus as solar power energy increases; recharging the batteries up to a maximum battery charge when solar power exceeds the solar powered charging of threshold; operating the desalinization apparatus using battery power when the solar power drops below the solar power stop threshold and the battery power is above the battery power stop threshold; and terminating operation of the hybrid desalinization apparatus when the solar power falls below the solar power stop threshold land the battery power falls below the battery power stop threshold.

### DESCRIPTION OF THE DRAWINGS

FIG. 1 is top plan, schematic, view of a reverse osmosis water desalinization system constructed in accordance with the present invention.

FIG. 2 is side elevation view of the energy recuperation apparatus of FIG. 1, taken substantially along the plane of line 2-2 in FIG. 1.

FIG. 3 is another side elevation view of the energy recuperation apparatus of FIG. 1, taken substantially along the plane of line 3-3 in FIG. 1.

FIG. 4 is an end elevation view of the energy recuperation apparatus of FIG. 1, taken substantially along the plane of line 4-4 in FIG. 1.

FIG. 5 is an end elevation view corresponding to FIG. 4 showing a moved position of the energy recuperation apparatus in broken lines.

FIG. 6 is a typical solar energy availability curve during a day at a desert site.

### BEST MODE OF CARRYING OUT THE INVENTION

The reverse osmosis water desalinization system of the present invention is directed to the problem of providing a system which is energy efficient and can provide potable water quality in relatively small installations, for example, in sizes varying from about 1,000 gallons per day to about 20,000 gallons per day. Typically, such a system will be used in connection with a source of sea water having a salinity in the range of about 25,000-40,000 total dissolved solids (TDS). It will be understood, however, that the same system can be used in connection with other water sources having much lower total dissolved solids. Since the desalinization burden is less, greater efficiency and lower cost per gallon would be expected from water desalinized from such sources

There are various standards as to what constitutes an acceptable level of dissolved solids, but many municipalities in the United States, for example, will accept 750 TDS as a goal, and in fact they often operate at levels as high as 90° TDS. Using the present apparatus and method, water quality between 500 and 650 TDS has regularly been achieved, with quality levels as high as 350-400 TDS being achievable with associated tradeoffs in cost per gallon. The nature of the dissolved solids also may require special treatment, but for most cases the solids are salts that do not result in the water being unpotable.

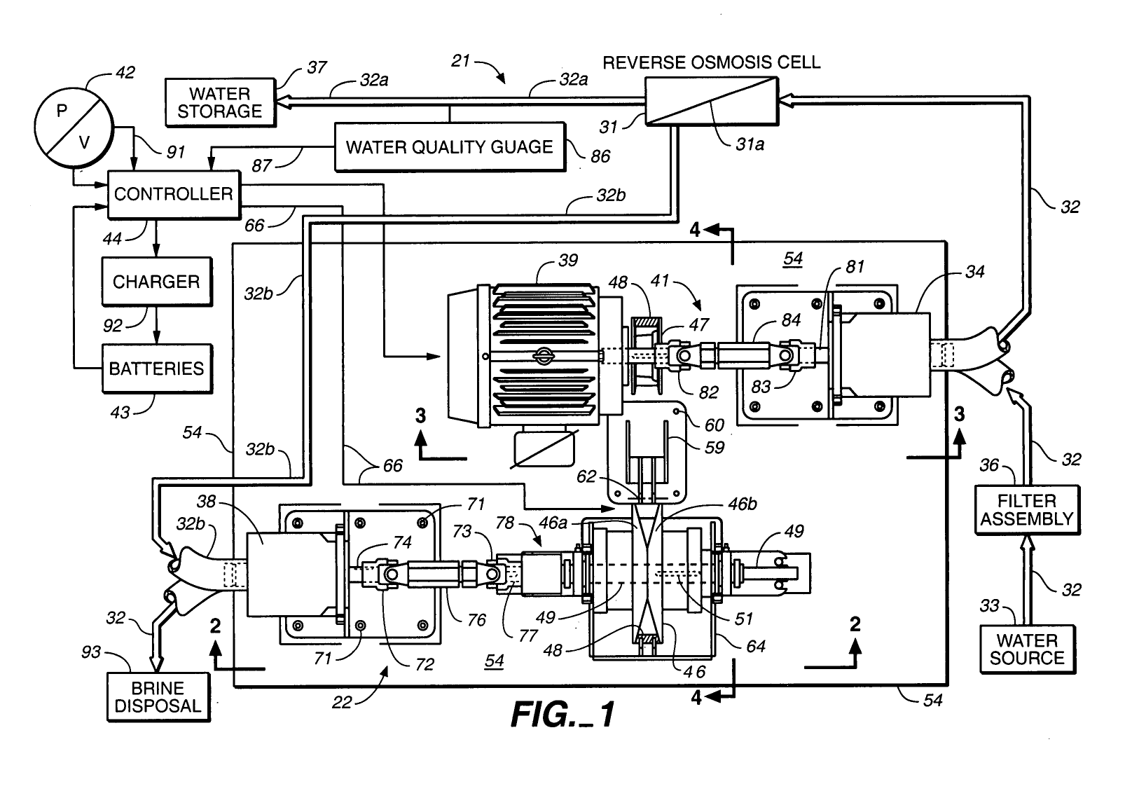

Turning now to FIG. 1, a reverse osmosis water desalinization system, generally designated 21, is shown which includes an energy recuperation assembly, generally designated 22. The energy recuperation assembly components are more specifically represented, while the remainder of the reverse osmosis system is shown schematically.

Desalinization system 21 includes a reverse osmosis cell 31 coupled by a fluid conduit array, generally designated 32, 32a and 32b, to a source of water 33, such as sea water. A hydraulic pump 34 pumps water from source 33, usually through a filter assembly 36 via conduits 32 to cell 31. Reverse osmosis cell 31 has two outputs, namely a desalinized water output conduit 32a, which is coupled to water storage tank 37, and a brine output conduit 32b, which is coupled to energy recuperation assembly 22. A motor, in this case an electric motor 39, is mechanically coupled through a drive train assembly 41 to pump 34, and motor 39 preferably is powered by a hybrid electrical power system including an array or plurality of photovoltaic (PV) cells 42 and a plurality of batteries 43, which are controlled by controller 44. In one aspect of the present invention, however, the novelty resides in energy recuperation assembly 22, and motor 39 can take other forms including fossil fuel motors, fuel cell-drive motors, electrical grid-driven motors, etc. In another aspect, the hybrid PV/battery powered system has been selected as the preferred power source, particularly for geographic areas having high and relatively steady available solar energy.

First, energy recuperation apparatus 22 of the present invention will be set forth. It is an important goal of the present invention to optimize the recouperation of energy coming from the brine stream output from reverse osmosis cell 31. Since the brine stream energy will vary as the system is operated, energy recouperation most advantageously will also vary under dynamic conditions of cell operation. Moreover, even small adjustments in the amount of energy recouperated and input back into pump 34 will produce significant differences in the overall system efficiency, making it highly desirable to be able to tune or subtly refine the energy recouperation employed in the desalinization apparatus.

The desalinization operating parameters are not stable. The following parameters, among others, regularly vary within a day's operation or from day-to-day: salinity of the water source, water temperature, cell membrane rejection (contamination due to the length of operation), and available electric power, which affects pump speed, water flow rate, and input pressure on the cell. Changing the recouperation input back into the pump will affect yield from the cell. When sufficient power is available, lower yield and lower efficiency can be tolerated in order to allow higher washing of the solids accumulated on the cell membrane surface. When the power supply is low, the yield of the membrane can be increased as the temporary deposition of solids on the membrane will not permanently damage the membrane.

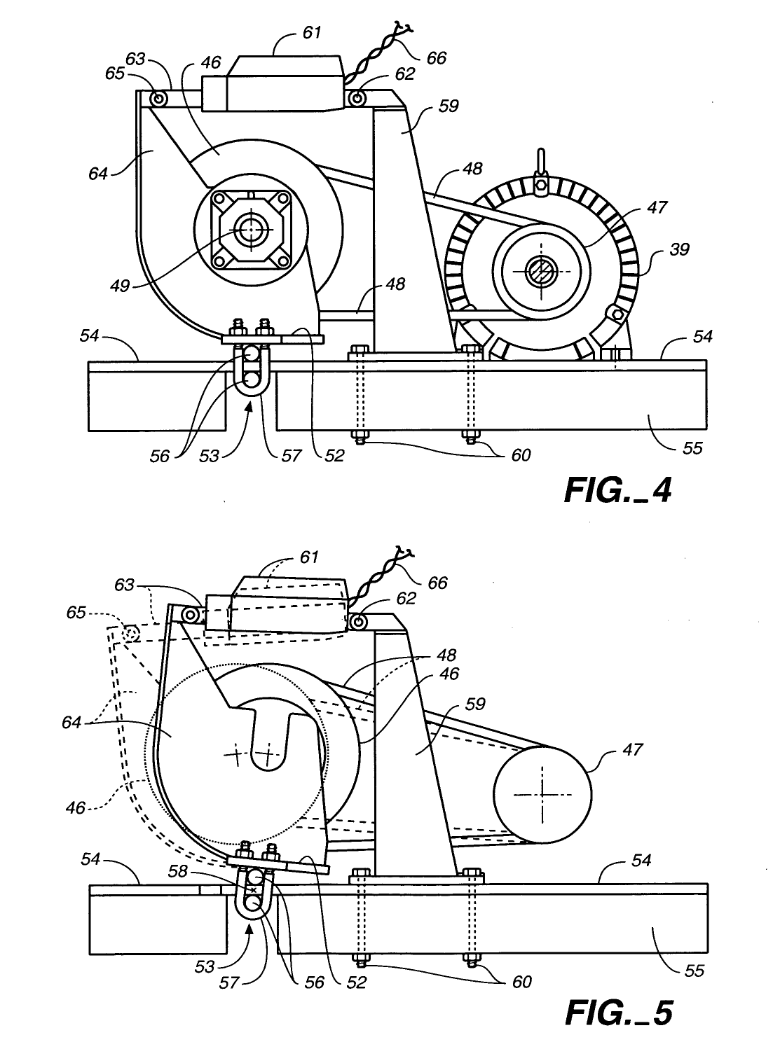

In the illustrated embodiment, the stepless, adjustable, ratio-increaser assembly is employed to mechanically couple a fixed displacement hydraulic motor 38 to pump 34. Ratio increaser assembly 22 may advantageously include a variable speed pulley assembly having a drive pulley 46 coupled to a driven pulley 47 by endless belt 48 (which is only shown in FIG. 1 in cross section on the two pulleys for the sake of clarity). Belt 48 is an endless belt which can be more clearly seen in FIGS. 4 and 5.

As will be seen from FIGS. 1, 4 and 5, drive pulley 46 is larger than driven pulley 47 so as to increase the rotational speed of the output from fixed displacement motor 38 that is input into pump 34. The ratio of the increase in rotational speed from drive pulley 46 to motor 47 has advantageously been found to be in the range of about 1.5 to about 2.0, but for components of differing size, it will be understood that other ranges of speed ratio increase could be employed. In the present invention a stepless variation of the speed ratios is preferred and employed to maximize efficiency of energy recuperation because relatively small ratio changes have been found to affect efficiency significantly.

As shown, drive pulley 46 includes a belt-tensioning assembly and is mounted in a manner which allows a stepless variation of the drive ratio between pulley 46 and pulley 47 with the range of about 1.5 to about 2.0.

Belt tensioning can be accomplished simply by providing pulley 46 as two sheave halves 46a and 46b which are mounted to shaft or axle 49 for axial movement along shaft 49. Sheave halves 46a and 46b are spring-biased toward each other by compression springs, not shown. As shown in the drawing, pulley halves 46a and 46b are axially displaceable along keyway 51 provided in shaft 49. Such tensioning assemblies, of course, are well known in the industry, and the axial spring force causes endless belt 48 to ride at a diameter on pulley 46 which maintains the tension in belt 48 at a desired level for any given relative distance between the drive pulley and the driven pulley. Driven pulley 47 is shown as a fixed diameter pulley. A reversal parts might be possible, but the smaller size of the driven pulley 47 makes it more desirable to provide for belt tensioning and ratio adjustment in drive pulley 46.

Adjustment of the speed ratio between pulleys in an infinitely variable or stepless fashion can best be understood by reference to FIGS. 4 and 5. In the present invention, at least one of the drive and the driven pulleys is movably mounted relative to the other so as to enable variation of the speed ratios within the designed operating range. This can be most clearly seen in FIG. 5 in which drive pulley 46 is mounted for movement toward or away from driven pulley 47. This again could be reversed, but it is more easily accomplished in connection with the drive pulley than the driven pulley and therefore is preferred.

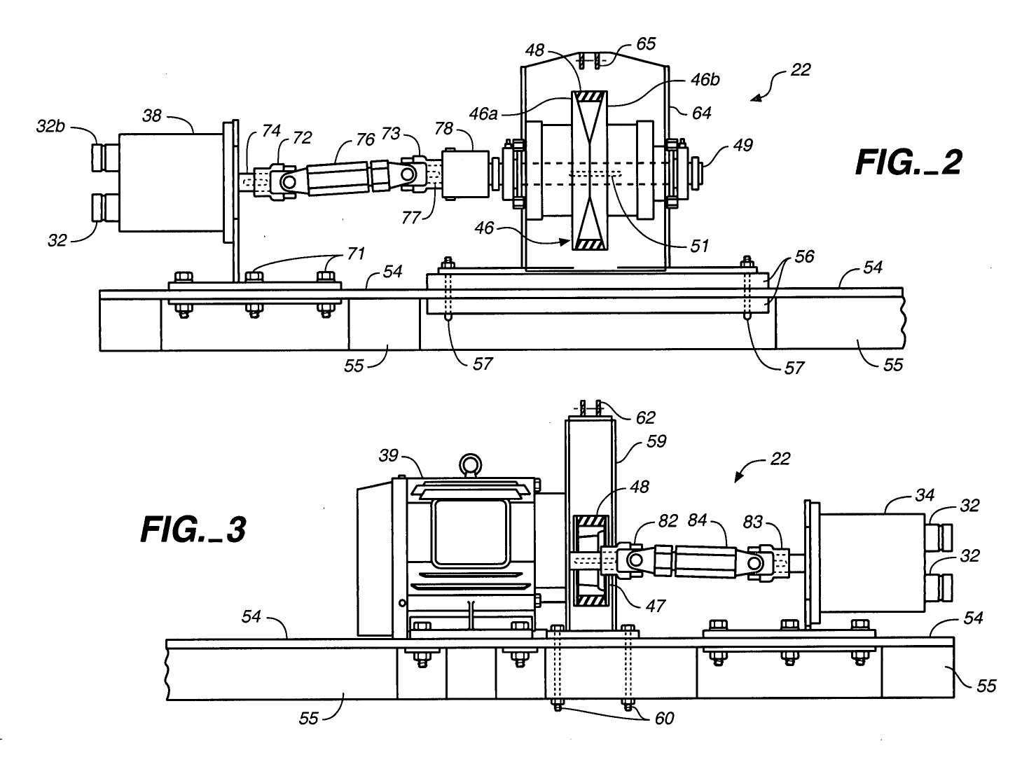

Various techniques can be used to movably mount drive pulley 46 relative to driven pulley 47, but in the illustrated assembly, drive pulley 46 is mounted for pivotal movement relative to the driven pulley. As illustrated in FIG. 5, driven pulley 46 is mounted to a frame member 52 that is coupled by a pivotal mount, generally designated 53, to a sub-platform or base member 54 on which the energy recuperation assembly is secured. In the preferred embodiment sub-platform 54 is a rubberized fabric member (for example, a piece of rubberized fabric conveyor or transmission belting) secured to a rigid base, such as a concrete or metal table 55 (FIGS. 2-5). The rubberized fabric sub-platform acts as an energy absorbing/isolating member which reduces vibration and noise. Pivotal mounting assembly 53 is shown as a pair of rods or shafts 56 that are positioned on the upper and lower sides of compressible rubberized platform 54 and coupled to drive pulley frame member 52 by a pair of spaced apart U-bolts 57 so as to cause pivoting about pivot point 58. Pivoting about point 58 is controlled by a U-shaped tower assembly 59 having an actuator 61 pivotally coupled at 62 to an upper end of the tower 59. A movable screw 63 is pivotally coupled at 65 to the upper end of pulley housing or frame member 64 which extends up from base plate 52 and carries drive pulley 46. Actuator 61 is shown as being coupled by electrical conductors 66 for input from electrical controller 44, but it will be understood that actuator 66 also could be pneumatic or hydraulic and controlled in various manners from controller 44.

As controlled by controller 44, actuator screw 63 is driven by a stepping motor with the combination providing an essentially stepless variation of the positions to which screw 63 can be extended or retracted. In FIG. 4, an intermediate position is shown, while an extended position is shown in dotted lines in FIG. 5 and a retracted position is shown in solid lines. In the extended position of FIG. 5, belt 48 will be forced down in drive pulley 46 toward a diameter which is closer to drive shaft 49, while in the retracted solid line position in FIG. 5, belt 48 will move to the largest diameter position on drive pulley 46. The axial belt tensioner causes belt tension at the large diameter position to be the same as belt tension in the smaller diameter position shown, in the manner which is well known to those skilled in the art. Thus, for all diameters at which belt 48 is positioned between sheave halves 46a and 46b, the belt tension will be the same and actuator 61 can be extended and retracted through almost an infinite number of positions to produce a stepless variation of the speed ratios between the smallest diameter on drive pulley 46 (a speed ratio of 1.5) and the largest diameter at which the belt can be positioned on drive pulley 46 (a speed ratio of 2.0).

As will be seen in FIGS. 4 and 5, the U-shaped tower 59 is coupled by fasteners 60 to platform or base member 54. Since the center of drive shaft 49 is moved through the range of positions (shown in FIG. 5), coupling of motor 38, which is fixedly bolted by bolts 71 to platform or base 54, to movable pulley 46 is preferably accomplished using universal shaft assembly including couplings 72 and 73. Coupling 72 is mounted on fixed displacement motor output shaft 74 and couples to an intermediate drive shaft 76, with coupling 73 being mounted to an input shaft 77 of a one-way clutch assembly 78 (which will be discussed hereinafter below) that in turn is coupled to pulley drive shaft 49. As is well known in the art, such universal shaft assemblies will accommodate a limited range of movement, for example, the range shown in FIG. 5, while still enabling the rotational output of motor shaft 74 to be transmitted to drive pulley shaft 49.

Use of the universal shaft assembly to pivotal drive pulley 46 allows components, such as, pump 34, motor 39 and motor 38 to be rigidly mounted to base or platform 54. This simple mechanical arrangement, with vibration isolating rubber/textile member 54 allows system vibration and noise suppression. An operating prototype, for example, enabled noise reduction of from about 90 decibels to about 75 decibels (scale A at five feet), when compared to a totally rigid system. It should also be noted that it is preferable to couple the output of driven pulley 47 to input shaft 81 by another universal shaft assembly 84 with couplings 82 and 83.

In order to avoid cavitation in hydraulic motor 38, which is driven by brine stream from cell 31, it is preferable that the energy recuperation system also include one-way clutch assembly 78 mechanically coupled between pump 34 and motor 38. One-way clutch 78 should be formed so that it will prevent rotation of pump 34 from being communicated back to motor 38. Since pump 34 is primarily being driven by an electrical motor 39, the rotational input to pump shaft 81 will also drive driven pulley 47, and such rotation of pulley 47 will be transmitted by belt 48 back to drive pulley 46. This rotation, in turn, will be communicated back to motor 38 through universal shaft assembly 76, unless a one-way clutch 78 is interposed so as to prevent driving of hydraulic motor 38 by electrical motor 39. If the hydraulic motor is driven by the electrical motor, and if there is no brine stream entering the hydraulic motor, for example, during start up conditions, there is a risk of cavitation. The risk of cavitation is eliminated by clutch 78, and hydraulic motor 38 will start turning only when brine flow through conduit 32b is available to motor 38.

Hydraulic motor 38 provides the function of a choke valve in the energy recuperation system, and the mechanical coupling through an adjustable ratio-increaser to the pump, as above-described, allows approximately 40 percent of the energy of electrical motor 39, which is used to drive pump 34, to be recuperated. It should be noted that it is also possible to supply hydraulic motor 38 with an additional flow of low-pressure sea water in order to prevent cavitation, but the use of one-way clutch 78 to prevent cavitation is simpler and more reliable.

The energy recuperation apparatus or assembly as above described was incorporated into a prototype reverse osmosis desalinization system and used to treat sea water having a salinity of about 33,400 TDS. One of the advantages of the recuperation system of the present invention is that it can be tuned to optimize the increaser ratio while measurements are taken, for example, by a water quality gauge 86 coupled to sense the quality of water in cell output pipe 32a. One form of sensor would be one which measures the total dissolved solids, although, other sensing criteria can also be employed.

In order to attain water quality below 750 TDS from water being treated with a salinity of about 33,000 TDS, the system was operated with the increaser ratio in the range of about 1.7 to about 1.8, which allowed energy recuperation in the range of about 38 to about 40 percent for the prototype being tested. This prototype will be described in more detail hereinafter. By communicating water quality sensing through electrical conductors 87 to controller 44, it is possible to communicate control signals through conductor 66 to actuator 61 so that dynamic adjustment of the increaser ratio can be accomplished as a function of water quality. Such a totally automatic dynamic adjustment was not attempted in the prototype, but manual adjustments were made, and the expected results realized.

The above-described recuperation system has application to reverse osmosis desalinization apparatus which are driven by a variety of different motors 39. As above noted, therefore, motor 39 can be a fossil fuel motor or an electrical motor driven off of a conventional electrical grid. Energy recuperation obviously will reduce the cost of desalted water production, regardless of the type of motor 39 used as the prime mover for the system.

In the present invention, however, it is preferable that motor 39 be an electrical motor and that it further be coupled to a hybrid photovoltaic/battery system. The selection of the components for such a hybrid electrical power system can be made from a wide range of possibilities. After testing various prototype systems and producing over 4.5 million gallons of water during over 32,000 hours of water production, an overall system economy of about 15 percent to about 20 percent can be obtained by using larger PV arrays working an average of only about 8 hours a day, rather than using a system of approximately one-quarter the size working 24 hours a day to produce the same quantity of water. The 24 hour per day system requires a larger battery storage capability so as to deliver sufficient energy to power the reverse osmosis system when there is no sun. Lead acid, deep-cycle batteries, which are the industry standard, are relatively economical in capital cost, but they offer a relatively short life (5-8 years). Batteries require careful maintenance and are ecologically troublesome when it comes to disposal. The overall efficiency of large battery storage systems is between about 40 and about 60 percent, depending mostly on the quality and condition of batteries and the ambient temperature. Using battery-stored energy in hybrid systems allows proper balancing of the system and production of a quality product at optimum specific efficiency.

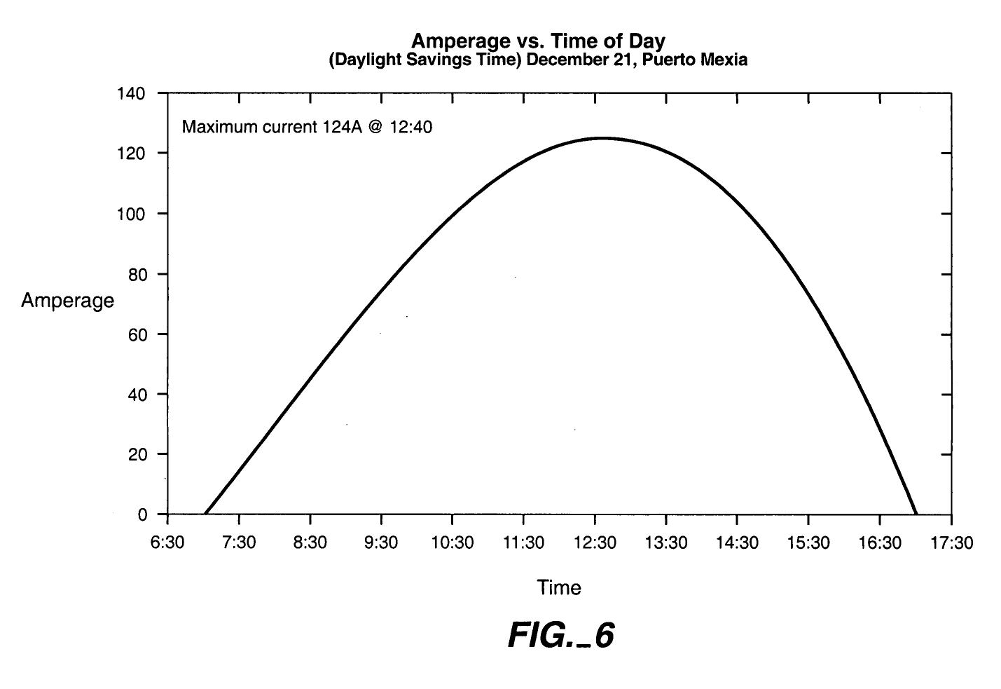

Rather than using a large storage battery array approach, however, it has been concluded that a reverse osmosis system producing water of a quality below 750 TDS can be achieved using a large PV panel array and a relatively small battery bank. Moreover, by operating pump 34 at different speeds, and by using different energy recuperation increaser ratios which can be matched to the non-constant supply of available solar energy during the day only, operation of reverse osmosis cells can be matched to the available solar energy during a day. FIG. 6 shows a typical solar energy availability curve for the prototype test site.

Prototype testing revealed that a battery system that works 24 hours per day requires an average solar hour panel capacity (equinox sun) of about 4.9 watts (photovoltaic) per gallon of produced water and approximately 176 watt hours of battery bank capacity per gallon. Conversely, however, a hybrid system operating only during daylight hours requires about 3.1 watts (photovoltaic) and 10.4 watt hours of battery bank capacity per gallon of water. It must be pointed out, however, that the average quality of water produced by the 24 hour per day system was better, for example, 350-450 TDS as compared to the 8 hour per day system, which produced water quality in the range of 500-650 TDS. The 8 hour per day hybrid system water quality could be increased, but system efficiency will drop. An additional advantage of the 8 hour or daylight only system is the extension of life of the main components, which work at a substantially lower duty cycle. Additionally, a daylight only system for reverse osmosis water desalinization allows maintenance time at night, whereas the 24 hour a day system required system shut down to perform maintenance tasks.

In a geographic area with continuous strong sun and minimal, fast moving, small clouds, the hybrid system of the present invention, with a minimum sized battery bank can be employed. The pump is driven using the PV panels as much as possible. Moreover, the present system has a start-up and shut-down process control which allows operation on the battery bank for a short period of time before the PV panels take over completely and a short period of time after the solar energy has dropped below a level to run the pump directly from solar energy. The battery bank also is of a size which will keep the system running during daylight hours when, for example, clouds pass in front of the sun. Thus, the battery bank size is used to extend the daylight hours, for example, by about a half an hour on each end of the day, and the battery bank size is selected to stabilize operation during the day when solar energy availability drops. This allows operation of the reverse osmosis cell for about 65 percent of the daylight hours. In locations where the sun may be obstructed by clouds for longer periods of time, the size of the battery bank should be increased to avoid system stoppage and operation of the pump at speeds which are too low for too long a period of time.

In osmotic cell 31 the osmotic pressure across membrane 31a, which is schematically shown, typically must exceed 365 pounds per square inch (psi). In order to gain a reasonably yield, the standard pressure used in the industry ranges from about 750 to about 1,100 psi. The working pressure of membrane 31a depends on the water salinity, membrane design, membrane yield, membrane cleanliness and water temperature, with cold water requiring higher pressure. The most common yield (the desalinized water volume to the total water volume pumped into cell 31) generating the best water at the best specific efficiency and still offering reasonable membrane life between cleaning is about 33 percent to about 38 percent. Changing the increaser ratio from about 1.7 to about 1.8 will typically generate an increase in the pressure on membrane 31a in the neighborhood of about 50 psi, but it is possible to run desalinization system 21 at lower pressures during start-up and stopping. There will be some quality fall off on the water produced at lower pressures, but this can be quite acceptable when, for example, the water storage tank 37 is large enough to reduce the effects of quality variation during start-up and stopping to a level which is still below the target total dissolved solids. Thus, for example, if tank 37 is large enough to hold three times the amount of water produced during an 8 hour run, the poorer quality water produced during start-up and stopping will be diluted by the high quality water produced during the high solar availability times of the day.

It is an important part of the process of the present invention, therefore, to operate the pump at lower rpm (a lower pressure on membrane 31) during start-up and stopping, and during temporary interruption of the solar power during the course of the day. This allows the system to be driven primarily by the PV panels and yet allows the total number of hours during the day of water processing to be extended over that of the optimum daylight hours using a combination of reduction of the pump speed and energy from a smaller battery bank.

While other pumps can be used, it also is preferable that pump 34 be a fixed displacement axial piston pump similar to motor 38. Axial piston pump 34 will have an efficiency at nominal rpm's (about 3400 rpm for a small pump and about 1500 rpm for a large 10 HP pump) in the low 90 percent area. While the efficiency of fixed displacement hydraulic motor 38 will be in the middle 80 percent area. The efficiency of both the hydraulic pump and hydraulic motor drops by 10-15 percent when there is a speed decrease from the nominal operating speed of about 50 percent. This suggests that the ability to dynamically adjust the increaser assembly ratio will be very effective in trying to maintain the efficiency and water quality as the pump and motor speeds are reduced, but such an automatic control, off water gauge 86 through the use of actuator 61 is controlled by the controller 54 will introduce additional complexity to the system.

### EXAMPLE

The reversal osmosis desalinization system of FIG. 1 has been prototyped, and the following is an example of high effective and efficient relatively small capacity system suitable for use by, for example, a single homeowner or small group of homeowners.

Six 4×40 inch membranes 31a are assembled into two twelve foot long vessels to form cell assembly 31. Pump 34 and motor 38 are provided by DANFOSS APP Model 2.2 Pumps/Motors, and a three-horse power 1760 rpm electric motor 39, operating at frequencies from about 45 to about 80 hertz, is used to drive pump 34. PV panels 42 are in an array of 10 panels producing a capacity of 3800 W(p) of photovoltaic energy at 48 VDC. Battery bank 43 is provided by 8 times 2.2 kilowatt hours at 6 volts, deep-cycle, lead-acid batteries.

The system was tested at a location having about 13.5 hours of daylight (in March around the equinox), with the system operating approximately 9 hours a day and producing 1300 gallons of desalted water per day. In the preferred form, the system is started when the battery voltage (at no load) is about 54 volts and the PV panels are delivering about 20 amps of current. It is necessary to provide a start signal from a separately controlled PV panel to controller 44, as indicated by arrow 91 in FIG. 1, since the voltage of battery bank 43 drops by approximately 12 percent when the load is applied. Use of the battery voltage as a start signal could produce system hunting, but a photovoltaic start threshold signal 91 can be employed to start the system when the available solar energy is still below that which would be sufficient to operate the pump using panels 42 as the only power source.

At system start-up, the frequency drops from about 64 hertz to about 56 hertz, and electrical motor 39 is drawing current from both panels 42 and batteries 43. In about 45 minutes, solar energy panels 42 will be delivering enough energy to run motor 39 alone, and the frequency at which pump 34 is driven by motor 39 will be increased by controller 44 to about 80 hertz over time. Controller 44 also begins to charge battery bank 43 through charger 92 as the photovoltaic energy increases. Batteries 43 are charged to full capacity and the driving frequency of motor 39 is limited by controller 44 to about 80 hertz. Charger 92 prevents over-charging of battery bank 43 if the solar energy available exceeds that required to run the pump at optimum speed and charge the batteries.

The system stop command can be issued by sensing the battery voltage from battery bank 43 or by using water quality gauge 86. As solar energy drops, controller 44 reduces the operating speed of motor 39 and pump 34 until the system is operating down around 45 hertz. Battery voltage is then being drawn through controller 44 to be used in combination with available lower PV power to run motor 39 and pump 34. When the battery voltage lowers to a stop threshold of about 47 volts, with the panels delivery under a PV stop threshold of about 10 amps, controller 44 will terminate operation of motor 39 and pump 34. After motor 39 and pump 34 are no longer operating, the remaining PV output can be directed by controller 44 to the battery charger to bring the batteries up to full charge before the solar energy is gone for the day.

During speed variation over the course of the day, the ratio increaser can be adjusted to increase the ratio of energy recouperation at the start and at the end of the day, for example, increasing the speed ration from 1.7 to 1.8, and during the middle of the day the system speed ratio maintained at about 1.7.

A typical start-up water quality experience would be that the first gallon of product would have a water quality of 4-6,000 TDS, the second gallon about 1,000 TDS and the third gallon about 650 TDS. Due to dilution of the large tank 37, for example 10,000 gallons, one can allow all of the product to go to tank 37. It will be understood, however, that a valve (not shown) controlled by gauge 86 also could be used to prevent the start-up water from entering tank 37.

1. A reverse osmosis water desalinization system comprising:
a reverse osmosis cell;
a hydraulic pump;
a motor coupled to drive the hydraulic pump;
a conduit array fluid coupling the hydraulic pump to a source of water and fluid coupling the hydraulic pump to the cell for pumping of water from the source through the cell; and
an energy recuperation assembly including a fixed displacement hydraulic motor fluid coupled to receive brine output from the cell and an adjustable ratio increaser assembly mechanically coupled between the output of the hydraulic motor and an input of the hydraulic pump.

2. The reverse osmosis system as defined in claim 1 wherein,
the adjustable ratio increaser assembly is a substantially stepless apparatus.

3. The reverse osmosis system as defined in claim 2 wherein,
the energy recuperation assembly includes a one-way clutch mechanically coupled between the hydraulic motor and the hydraulic pump and formed to prevent rotation of the hydraulic pump from being communicated back to the hydraulic motor.

4. The reverse osmosis system as defined in claim 3 wherein,
the ratio increaser assembly includes a variable speed pulley assembly having a variable speed drive pulley coupled to the output of the hydraulic motor, a driven pulley coupled to the input of the hydraulic pump, and an endless pulley belt mounted between the drive pulley and the driven pulley.

5. The reverse osmosis system as defined in claim 4 wherein,
the one-way clutch assembly is mounted between the pulley assembly and the hydraulic motor.

6. The reverse osmosis system as defined in claim 1 wherein,
the hydraulic pump and the hydraulic motor are a fixed displacement axial piston pump and a fixed displacement axial piston motor.

7. The reverse osmosis system as defined in claim 4 wherein,
the pulley assembly further includes a belt tensioning assembly formed to apply a tensioning force to the endless belt.

8. The reverse osmosis system as defined in claim 7 wherein,
the belt tensioning assembly is provided by an axially mounted compression spring biasing an axially movable sheave wall of the drive pulley to tension the endless belt.

9. The reverse osmosis system as defined in claim 4 wherein,
one of the drive pulley and the driven pulley are movably mounted to a support surface for selective adjustment of the drive ratio therebetween.

10. The reverse osmosis system as defined in claim 9 wherein,
the drive pulley is pivotally mounted for movement toward and away from the driven pulley, and the hydraulic motor is coupled to the drive pulley by a universal shaft assembly.

11. The reverse osmosis system as defined in claim 10 wherein,
the drive pulley includes an adjustable link coupled to enable selective pivoting of the drive pulley toward and away from the driven pulley.

12. The reverse osmosis system as defined in claim 11 wherein,
the pulley assembly and adjustable link are formed for stepless variation of the ratio of the speeds of rotation of the driven pulley to the drive pulley in the range of between about 1.5 to about 2.0.

13. The reverse osmosis system as defined in claim 1 wherein,
the cell, motor, hydraulic pump and energy recuperation assembly are mounted on a rubberized energy absorbing member, and the rubberized member is mounted to a rigid base.

14. The reverse osmosis system as defined in claim 1 wherein,
the motor is an electrical motor.

15. The reverse osmosis system as defined in claim 14, and
a hybrid battery and photovoltaic electric power assembly electrically connected to the electric motor.

16. The reverse osmosis system as defined in claim 15 wherein,
the hybrid battery and photovoltaic electric power assembly includes:
a plurality of rechargeable batteries;
a plurality of photovoltaic panels; and
a controller electrically connected to the batteries, to the panels, and to the electrical motor, the controller being responsive to electrical input from the panels and batteries to control operation of the electric motor.

17. The reverse osmosis system as defined in claim 16 wherein,
the controller is responsive to varying power output from the panels and the battery to vary the rate at which water is pumped to the cell.

18. The reverse osmosis system as defined in claim 17 wherein,
the controller is formed to use power from the panels in preference to power from the batteries.

19. The reverse osmosis system as defined in claim 16 wherein,
the controller is responsive to electrical input from the panels and batteries to start operation of the pump at a rate proximate a low end of a speed range for operation of the pump when the current output from the panels exceeds a panel start threshold if the voltage output of the batteries also exceed a battery start threshold, and the controller operates the pump at a low end speed using power from both the panels and the batteries.

20. The reverse osmosis system as defined in claim 19 wherein,
the controller is responsive to electrical input from the panels to increase the rate of operation of the pump using electrical power from the panels as current output from the panels increases until a maximum pump operation speed is reached.

21. The reverse osmosis system as defined in claim 20, and
a battery charger electrically connected to the controller and the batteries, the battery charger being formed to prevent overcharging of the batteries; and wherein
the controller is responsive to electrical input from the panels to recharge the batteries using the battery charger when the power output from the panels exceeds the power necessary to operate the motor at the maximum speed.

22. The reverse osmosis system as defined in claim 19 wherein,
the controller is responsive to electrical input from the panels and the batteries to terminate operation of the motor and pump when the battery voltage lowers below a stop voltage threshold and the panels output current is below a stop current threshold.

23. The reverse osmosis system as defined in claim 19 wherein,
the stop voltage threshold is above the start voltage threshold and the stop current threshold is below the start current threshold.

24. The reverse osmosis system as defined in claim 19, and
a water quality sensor positioned to sense the quality of desalinized water produced by the cell and electrically coupled to the controller to send water quality signals to the controller; and wherein,
the controller is responsive to electrical input from the batteries and the water quality signals from the water quality sensor to terminate operation of the motor and pump when the battery voltage lowers below a stop voltage and the water quality signals lower below a water quality stop signal threshold.

25. A method of desalting water comprising the steps of:
pumping water to be desalted through a reverse osmosis cell using a hydraulic pump;
flowing brine output from the cell through a fixed displacement hydraulic motor; and
mechanically coupling the output of the fixed displacement hydraulic motor to the input of the hydraulic pump by an adjustable ratio increaser assembly.

26. The method as defined in claim 25 wherein,
the mechanically coupling step is accomplished by mounting a variable speed pulley assembly between the motor and the pump.

27. The method as defined in claim 26 and the step of:
mounting a one-way clutch assembly between the motor and the pump, the one-way clutch assembly being formed to prevent rotation of the motor by driving of the pump.

28. The method as defined in claim 26 wherein,
the step of mounting a variable speed pulley assembly is accomplished by movably mounting a drive pulley to a support surface for movement toward and away from a driven pulley to enable a change of the drive ratio between the drive pulley and the driven pulley.

29. The method as defined in claim 25 wherein,
the pumping step is accomplished by driving the hydraulic pump using an electric motor mechanically coupled to the hydraulic pump and electrically coupled through a controller to a hybrid photovoltaic and battery electrical power assembly.

30. The method as defined in claim 29 wherein,
the hybrid photovoltaic and battery electrical power assembly includes sufficient photovoltaic panels to power the electric motor and pump during selected daylight hours and a plurality of batteries sufficient to extend pump operation beyond the selected daylight hours only by an amount less than 10 percent of the operation of the motor and pump using the photovoltaic panels.

31. A method of desalting water comprising:
employing a hybrid battery and solar powered reverse osmosis desalinization apparatus;
starting operation of the desalinization apparatus using a combination of solar energy and battery energy when solar power is above a solar power start threshold and the battery power is above a battery power start threshold;
increasing the use of solar power energy to operate the desalinization apparatus as solar power energy increases during daylight hours;
recharging the batteries up to a maximum battery charge when the solar power exceeds the solar power charging threshold;
operating the desalinization apparatus using battery power when the solar power drops below the solar power stop threshold and the battery power is above the battery power stop threshold; and
terminating operation of the hybrid desalinization apparatus when the solar power falls below the solar power stop threshold and the power falls below the battery power stop threshold.
